(19) United States
(12) Patent Application Publication
(10) Pub. No.: US 2017/0232278 A1
(43) Pub. Date: Aug. 17, 2017

(54) RESPIRATOR MADE FROM IN-SITU AIR-LAID WEB(S)

(71) Applicant: 3M INNOVATIVE PROPERTIES COMPANY, St. Paul, MN (US)

(72) Inventors: John T. Tushaus, Oakdale, MN (US); Tien T. Wu, Woodbury, MN (US); Gerry A. Hoffdahl, Scandia, MN (US)

(21) Appl. No.: 15/585,494

(22) Filed: May 3, 2017

Related U.S. Application Data
(62) Division of application No. 13/315,881, filed on Dec. 9, 2011.

(51) Int. Cl. A62B 23/02; A62B 18/08; B29C 70/54; A62B 18/02; B29C 70/12; B29C 70/34

(52) U.S. Cl. CPC A62B 23/025; B29C 70/12; B29C 70/342; B29C 70/54; A62B 18/02; A62B 18/084; B29L 2031/4835

(57) ABSTRACT

A method of making a filtering face piece respirator, which method includes: providing a cup shaped mold 20; providing a forming chamber 24 where the mold 20 is located and where loose fibers 22 are introduced into air in the forming chamber 24; causing the loose fibers 22 to be accumulated 10 on the mold 20 in the forming chamber 24; and bonding 12 the accumulated fibers to each other at points of fiber intersection, The inventive method thus is beneficial in that it eliminates steps in the manufacturing process. The fibers also are uniformly distributed throughout the mask body, and because the webs do not have to be cut during respirator manufacture, less web waste is generated.

The present invention pertains to a method of making a filtering face piece respirator where at least one of the fibrous webs that comprises the mask body is made on the mold itself.

### BACKGROUND

Workers regularly wear respirators over their nose and mouths for at least one of two purposes: (1) to prevent impurities or contaminants from entering the wearer's breathing tract; and (2) to protect other persons or things from being exposed to bacteria and other contaminants exhaled by the wearer. In the first situation, the mask is worn in an environment where the air contains particles harmful to the wearer, for example, in an auto body shop. In the second situation, the mask is worn where another person or thing may be exposed to the exhaled contaminants, for example, in an operating room or clean room.

Some respirators are categorized as being “filtering face-piece” respirators because the mask body itself functions as the filtering mechanism. Unlike respirators that use rubber or elastomeric mask bodies in conjunction with attachable filter cartridges or filter liners (see, e.g., U.S. Pat. RE39,493 to Yuschak et al. and U.S. Pat. No. 5,094,236 to Tayebi) or insert-molded filter elements (see, e.g., U.S. Pat. No. 4,790,306 to Braun), filtering face-piece respirators have the filter media extend over much of the whole mask body so that there is no need for installing or replacing a filter cartridge. As such, filtering face-piece respirators are relatively light in weight and easy to use.

Filtering face-piece respirators are commonly made from thermally bonding fibers. Thermally bonding fibers bond to adjacent fibers after being heated and cooled. Examples of filtering face piece respirators formed from such fibers are shown in U.S. Pat. No. 4,807,619 to Dyrud et al. and U.S. Pat. No. 4,536,440 to Berg. The respirators disclosed in these patents are cup-shaped masks that have at least one layer of thermally bonding fibers. The layer of thermally bonding fibers is termed a “shaping layer” and is used to provide shape to the mask and support for a filtration layer. The shaping layers disclosed in U.S. Pat. Nos. 4,807,619 and 4,536,440 have been made by molding non-woven webs of thermally bonding fibers in heated molds. The heated molds operate at temperatures above a softening point of the bonding component of the thermally bonding fibers. A web of thermally bonding fibers is placed in the heated mold and is subjected to pressure and heat to form a shaping layer for a face mask. This kind of molding operation is known as a “hot molding process”.

Filtering face-piece respirators also have been made by “cold molding processes” where a previously prepared nonwoven web is first heated and then is placed, while heated, in a “cold mold”. The mold is referred to as being “cold” since the molding members are at a temperature below the softening point of the thermally bonding fibers in the web. An example of a cold molding process is disclosed in U.S. Pat. No. 7,131,442B1 to Kronzer et al.—see also U.S. Pat. No. 4,850,347 to Skov. In both hot and cold molding operations, the molded web is prefabricated, that is, it is already assembled before being placed on the molding members for conversion into a cup-shaped structure.

### SUMMARY OF THE INVENTION

The present invention provides a new method of making a filtering face piece respirator. The new method comprises: (a) providing a cup-shaped mold; (b) providing a forming chamber where the mold is located and where loose fibers are introduced into air in the forming chamber; (c) causing the loose fibers to be accumulated on the mold in the forming chamber; and (d) bonding the accumulated fibers to each other at points of fiber intersection to form a cup-shaped filtering face piece respirator.

The present invention also provides a filtering face piece respirator that comprises a mask body that comprises an in situ web—that is, it comprises a web that had been formed on the mold itself The respirator also has a harness that is secured to the mask body.

The present invention differs from known methods of making filtering face piece respirators in that the fibrous web(s) that comprises the mask body is made on the mold. In known respirator manufacturing processes, the nonwoven fibrous webs that comprise the mask body are premade—that is, they are assembled before being placed on the mold. In the present invention, one or more of the webs of the mask body becomes assembled on the mold where the mask body is made. The inventive method thus is beneficial in that it eliminates steps in the manufacturing process. The nonwoven webs that are used to make the respirators do not need to be pre-assembled, transported, unrolled, cut, and introduced into a respirator mask body assembly process. The resulting respirator also can have the fibers more uniformly distributed throughout the mask body. The fibers in the web may not become stretched from their placement on the mold since the web that comprises the mask body is formed on the mold itself And, because the webs do not have to be cut during the assembly of the respirator, less web waste may be generated in the respirator manufacturing process. The fibers that are unused in the forming chamber can be collected and be reintroduced into the chamber.

### GLOSSARY

The terms set forth below will have the meanings as defined:

“active particulate” means particles or granules that are specially suited to perform some action or function such as sorption (adsorption and/or absorption) which may be attributable to some characteristic or property including chemical properties such as catalysis and ion exchange;

“bicomponent fiber” means a fiber composed of two or more components comprising different polymeric compositions having dissimilar softening temperatures, which components are arranged in separate and distinct regions along the length of the fiber;

“binder fiber” means thermally bondable fibers;

“comprises (or comprising)” means its definition as is standard in patent terminology, being an open-ended term that is generally synonymous with “includes”, “having”, or “containing”. Although “comprises”, “includes”, “having”, and “containing” and variations thereof are commonly-used, open-ended terms, this invention also may be suitably described using narrower terms such as “consists essentially of”, which is semi open-ended term in that it excludes only those things or elements that would have a deleterious effect on the performance of the inventive respirator in serving its intended function;

“clean air” means a volume of atmospheric ambient air that has been filtered to remove contaminants;

“contaminants” means particles (including dusts, mists, and fumes) and/or other substances that generally may not be considered to be particles (e.g., organic vapors, et cetera) but which may be suspended in air, including air in an exhale flow stream;

“cover web” means a nonwoven fibrous layer that is not primarily designed for filtering contaminants;

“cup-shaped” means having a shape, such that if the product was solid, it would retain liquid if held upright with the open end facing upward;

“exterior gas space” means the ambient atmospheric gas space into which exhaled gas enters after passing through and beyond the mask body and/or exhalation valve;

“fiber” or “fibers” means a naturally made, or synthetically produced, slender elongated structure(s);

“filtering face-piece” means that the mask body itself is designed to filter air that passes through it; there are no separately identifiable filter cartridges, filter liners, or insert-molded filter elements attached to or molded into the mask body to achieve this purpose;

“filter” or “filtration layer” means one or more layers of air-permeable material, which layer(s) is adapted for the primary purpose of removing contaminants (such as particles) from an air stream that passes through it;

“filtering structure” means a construction that is designed primarily for filtering air;

“forming chamber” means a defined or definable volume of space where fibers may be accumulated on a surface intended for such accumulation;

“harness” means a structure or combination of parts that assists in supporting the mask body on a wearer's face;

“in situ” means made on the mold where molding occurs;

“integral” means that the parts in question were made at the same time as a single part and not two separate parts subsequently joined together;

“interior gas space” means the space between a mask body and a person's face;

“loose fibers” means fibers that have not been assembled into web form;

“mask body” means an air-permeable structure that is designed to fit over the nose and mouth of a person and that helps define an interior gas space separated from an exterior gas space;

“mold” means a device that is used to form a product into a desired shape or configuration though application of heat and/or pressure;

“nonthermally bonded” means the fibers do not substantially bond to adjacent contacting fibers after being heated to a temperature suitable for molding the web into which the nonthermally bonded fibers are contained;

“nonwoven” means a structure or portion of a structure in which the web components are held together by a means other than weaving;

“polymeric” and “plastic” each mean a material that mainly includes one or more polymers and may contain other ingredients as well;

“porous” means air permeable;

“plurality” means two or more;

“respirator” means an air filtration device that is worn by a person on the face over the nose and mouth to provide clean air for the wearer to breathe;

“shaping layer” means a layer that has sufficient structural integrity to retain its desired shape (and the shape of other layers that are supported by it) under normal handling;

“softening temperature” means the lowest temperature at which a fiber component is softened to an extent that permits that fiber component to bond to another fiber and retain that bonded condition when cooled;

“staple fiber” means fibers of determinate length;

“substrate” means a layer that resides below;

“sucking” means to draw in or through by creating a lower pressure or a vacuum (in whole or in part) or by otherwise creating an air current;

“suprastrate” means a layer that resides above;

“thermally bonding (or bondable) fibers” mean fibers that bond to adjacent contacting fibers after being heated above their softening temperature and subsequently cooled; and

“web” means a manually handleable structure that is significantly larger in two dimensions than in a third and that is air permeable.

### BRIEF DESCRIPTION OF THE DRAWINGS

FIG. 1 is a schematic diagram of steps that may be used in the method according to the present invention.

FIG. 2 is a schematic representation of a method of making respirators according to the present invention.

FIG. 3 is a perspective view of a respirator 40 in accordance with the present invention.

FIG. 4 is a cross section taken through the respirator mask body 42.

### DETAILED DESCRIPTION OF PREFERRED EMBODIMENTS

In the practice of the present invention, a new method of making a filtering face piece respirator is provided, which method comprises the steps of: providing a cup shaped mold; providing a forming chamber (such as a room or enclosed area) where the mold is located and where loose fibers are introduced therein; causing the loose fibers to be accumulated on the mold; and bonding the fibers to each other at points of fiber intersection. In traditional methods of molding disposable respirators, generally flat, bonded, nonwoven, pre-assembled webs are pressed while heated in a mold. When subject to such pressure, they can become stretched and deformed, leading to web uniformity problems in the molded product. Also, when the round respirator shapes are cut from the flat web during respirator manufacture, substantial waste can be produced.

The process described herein can alleviate these problems. Directly forming the web into a desired respirator shape before or during thermal bonding reduces the need for further post-bond processing that can degrade web uniformity. Forming the respirator shape before the accumulated fibers are thermally bonded also offers the potential to remove excess material before bonding, and to allow that material to be reused instead of being discarded. Additionally, it may be possible to use this process to incorporate reused fibrous scrap material, or other recycled materials, as a way to further build good economic and environmental practices into respirator manufacturing.

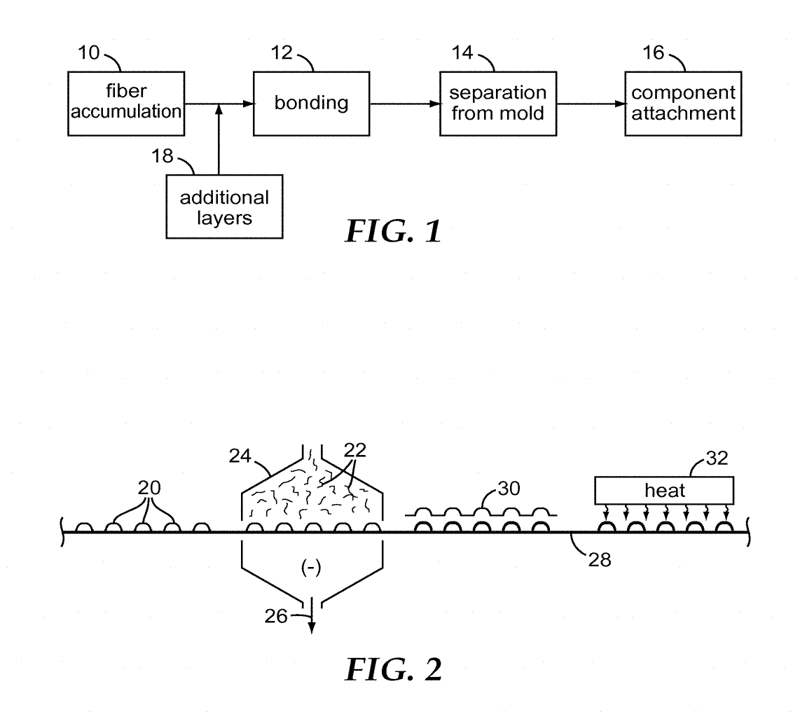

FIG. 1 shows an example of how a filtering face piece respirator may be made in accordance with the present invention. A cup-shaped mold is placed in a forming chamber where the loose fibers become accumulated 10 on the mold. The accumulation may be encouraged using, for example, a partial vacuum that draws air in the forming chamber through a porous mold. Alternatively or additionally, the molding members may have a means for causing the fibers to reside on the mold when they make such contact from vacuum, blower and/or gravity movement. Such a means for encouraging the fiber accumulation may include a roughened texture or small pins disposed on the outer surface of the mold where the fibers make contact. The loose fibers may be blown, drawn, or dropped into the forming chamber. As they move throughout the forming chamber, they may make contact with the outer surface of the molds. The textured surface causes the fibers to remain in contact with, or accumulate on, the molding members. Excess loose fibers that accumulate at the bottom of the forming chamber or elsewhere may be removed from the forming chamber and may be later reintroduced into the forming chamber to eliminate or minimize waste.

Once the loose fibers have accumulated on the mold, the fibers are bonded 12 to each other at points of fiber intersection. The bonding may be achieved by heating the accumulated fibers to a temperature above the softening temperature of one or more of the bonding component(s) of the fibers. Once the fibers have been bonded sufficiently, the resulting molded mask body may be separated 14 from the molds. A harness may then be attached 16 to the molded mask body to create a filtering face piece respirator suitable for use in an environment where contaminants need to be filtered from the ambient air. Alternatively, the harness could be attached to the mask body before the latter is separated from the mold. An exhalation valve also can be attached to the mask body if so desired. Additional layers of filter material or shaping layers also may be introduced 18 onto the molds before or after the fibers in the forming chamber have been placed onto the molds. Thus the additional layers may become a substrate or a suprastrate to the air laid web that is being created on the mold. The additional layers also could be cover webs located on one or both sides of the fibrous web formed on the mold in the forming chamber. Although the introduction of the additional layers 18 is illustrated as occurring after the fibers are accumulated on the mold, the additional layers may be introduced before such accumulation (as a substrate) or after the bonding step (as a suprastrate).

FIG. 2 shows that the inventive process may use porous molds 20 in the shape of a respirator mask body to collect the loose fibers 22 that are used to assemble one or more layers of the resulting mask body. A mixture of loose fibers 22 such as microfibers, bonding fibers, and staple fibers may be delivered into the forming chamber 24. Air may be drawn 26 from the forming chamber 24 to cause air also to be sucked through the porous molds 20. When the air in the forming chamber is drawn through the porous molds, the loose fibers 22 in the forming chamber 24 are coaxed onto those molds. The mold may have a screen or other porous medium on it to create a porous mold. The porous medium is configured in the shape of the intended mask body. The porous mold may be placed on a moving vacuum belt 28 before or as it enters the forming chamber 24. When the vacuum belt 28 carries the molds 20 across the forming chamber 24, a fan such as a condenser fan may pull air 26 from the forming chamber 24 through the mold 20. The resulting air movement within the forming chamber 24 draws loose fibers towards the mold 22, causing them to be trapped on the mold surface, or on the surface of a premade web that had been placed thereover. The forming chamber 24 may contain one or more transparent portions, such as a window or glass sidewall, so that the fiber collection process may be viewed by persons responsible for making the mask shells. After the molds 20 have travelled across the forming chamber 24, a second set of molds 30 may be placed over the first molds 20 to hold the accumulated fibers in place. The mold-fiber-mold sandwich can then be placed in an oven or beneath a heating unit 32 to bond the fibers together such that the bonded fibers maintain the desired respirator shape once the molded web has been removed from the mold. The basis weight of the molded product can be controlled by varying the loose fiber feed rate, the rate of the conveyer, and the air flow rate through the porous molds. The inventive process also makes it possible to add active particulate such as activated carbon into the loose fiber feed stream as the web is being formed into a three dimensional shape. This step can reduce the number of process steps and the complexity of machinery needed to generate a finished respirator containing an active particulate or other added components—like the particle-containing fibrous web described in U.S. Patent Application 2006/0254427A1 to Trend et al. Additionally, two or more forming chambers can be placed in sequence so that a plurality of layers (1, 2, 3, 4, or 5 or more layers) can be assembled. Thus, a first forming chamber may be used to form an underlying shaping layer for a mask body, while a second forming chamber may be used to create a filtration layer, and a third forming chamber may be used to create a cover web. More than one fibrous web therefore may be made on the mold in a series of forming chambers, and the plurality of webs may be secured together at the perimeter by, for example, ultrasonic welding.

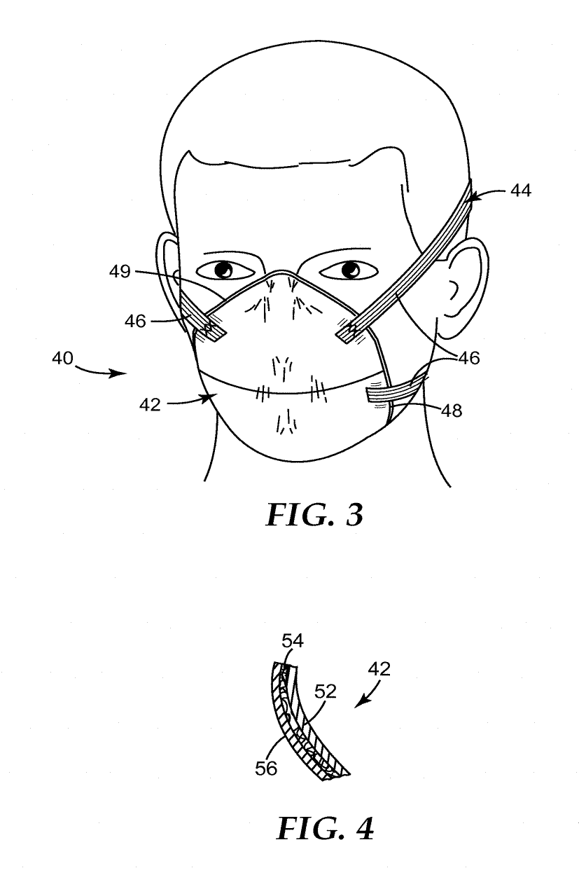

FIG. 3 shows an example of a filtering face-piece respiratory mask 40 that comprises a mask body 42 and a mask harness 44 and that may be made according to the present invention. The harness 44 may comprise one or more straps 46 that may be made from an elastic material. The harness straps 46 may be secured to the mask body 42 by a variety of means including adhesive means, bonding means, or mechanical means (see, for example, U.S. Pat. No. 6,729,332 to Castiglione). The harness 46 could be, for example, ultrasonically welded to the mask body or stapled to the mask body. Examples of other harnesses that could possibly be used are described in U.S. Pat. No. 5,394,568 to Brostrom et al. and U.S. Pat. No. 5,237,986 to Seppala et al. and in EP 608684A to Brostrom et al. The mask body 42 has a periphery 48 that is shaped to contact the face of the wearer over the bridge of the nose, across and around the cheeks, and under the chin. The mask body 42 forms an enclosed interior gas space around the nose and mouth of the wearer and can take on a curved, hemispherical shape as shown in the drawings or it may take on other shapes as so desired. For example, the shaping layer and hence the mask body can have the cup-shaped configuration like the filtering face mask disclosed in U.S. Pat. No. 4,827,924 to Japuntich. A malleable nose clip can be secured on the outer face of the mask body 42, centrally adjacent to its upper edge, to enable the mask to be deformed or shaped in this region to properly fit over a particular wearer's nose. An Example of a suitable nose clip is shown and described in U.S. Pat. No. 5,558,089 and Des. U.S. Pat. No. 412,573 to Castiglione. The mask body 42 also may have an optional corrugated pattern that may extend through all or some of the layers of the central region of the mask body 42 to improve product crush resistance.

FIG. 4 shows that the mask body 42 may comprise an inner shaping layer 52 that has a layer of filter material 54 on its radially outward side, and, on the radially outward side of the filter layer 54, an outer cover web 56 that too assumes the general shape as the shaping layer 52. The function of the shaping layer 52 is primarily to maintain the mask body shape and to support the filter layer 54. Although the shaping layer 52 also may function as a coarse initial filter for air that is drawn into the mask, the predominant filtering action of the mask 10 is provided by the filter layer 54. An outer shaping layer also could be disposed on the radially outward side of the filter layer 54 in between the filter layer 54 and the outer cover web 56. In addition to the illustrated assembled layers, the mask body 42 also could include a foam seal around the mask perimeter—see, for example, U.S. Pat. No. 4,827,924 to Japuntich—particularly in the nose area. Such a seal could include a thermochromic fit-indicating material that contacts the wearer's face when the mask is worn. Heat from the facial contact causes the thermochromic material to change color to allow the wearer to determine if a proper fit has been established—see U.S. Pat. No. 5,617,749 to Springett et al. The mask body 42 also could be provided with an inner cover web to provide improved comfort to the wearer on the inner side of the mask and to trap any fibers that may come loose from the shaping layer 52. The construction of such a cover web is described below along with descriptions of the shaping and filtration layers.

### Shaping Layer

The shaping layer(s) may be made in accordance with the present invention from at least one layer of fibrous material that can be molded to the desired shape with the use of heat and/or pressure and that retains its shape when cooled. Shape retention is typically achieved by causing the fibers to bond to each other at points of contact between them, for example, by fusion or welding. Any suitable material known for making a shape-retaining layer of a direct-molded respiratory mask may be used to form the mask shell, including, for example, a mixture of synthetic staple fiber, preferably crimped, and bicomponent staple fiber. Bicomponent fiber is a fiber that includes two or more distinct regions of fibrous material, typically distinct regions of polymeric materials. Typical bicomponent fibers include a binder component and a structural component. The binder component allows the fibers of the shape-retaining shell to be bonded together at fiber intersection points when heated and cooled. During heating, the binder component flows into contact with adjacent fibers. The shape-retaining layer can be prepared from fiber mixtures that include staple fiber and bicomponent fiber in a weight-percent ratios that may range, for example, from 0/100 to 75/25. Preferably, the material includes at least 50 weight-percent bicomponent fiber to create a greater number of intersection bonding points, which, in turn, increase the resilience and shape retention of the shell.

Suitable bicomponent fibers that may be used in the shaping layer include, for example, side-by-side configurations, concentric sheath-core configurations, and elliptical sheath-core configurations. One suitable bicomponent fiber is the polyester bicomponent fiber available, under the trade designation “KOSA T254” (12 denier, length 38 mm), from Kosa of Charlotte, N.C., U.S.A., which may be used in combination with a polyester staple fiber, for example, that available from Kosa under the trade designation “T259” (3 denier, length 38 mm) and possibly also a polyethylene terephthalate (PET) fiber, for example, that available from Kosa under the trade designation “T295” (15 denier, length 32 mm). Alternatively, the bicomponent fiber may comprise a generally concentric sheath-core configuration having a core of crystalline PET surrounded by a sheath of a polymer formed from isophthalate and terephthalate ester monomers. The latter polymer is heat softenable at a temperature lower than the core material. Polyester has advantages in that it can contribute to mask resiliency and can absorb less moisture than other fibers.

Alternatively, the shaping layer can be prepared without bicomponent fibers. For example, fibers of a heat-flowable polyester can be included together with staple, preferably crimped, fibers in a shaping layer so that, upon heating of the web material, the binder fibers can melt and flow to a fiber intersection point where it forms a mass, that upon cooling of the binder material, creates a bond at the intersection point. A mesh or net of polymeric strands could also be used in lieu of thermally bondable fibers to create a shaping layer. An example of this type of a structure is described in U.S. Pat. No. 4,850,347 to Skov. The mesh could be introduced into the process before or after a fibrous web is accumulated on the porous mold.

When a fibrous web is used as the material for the shape-retaining shell, the fibers can be delivered to the forming chamber as one or more, or a collection, of loose fibers. When a web is introduced into the forming chamber, the web can be conveniently prepared on a “Rando Webber” air-laying machine (available from Rando Machine Corporation, Macedon, New York) or a carding machine. In either instance, the web can be formed from bicomponent fibers or other fibers in conventional staple lengths suitable for the equipment. To obtain a shape-retaining layer that has the required resiliency and shape-retention, the layer preferably has a basis weight of at least about 100 g/m², although lower basis weights are possible. Higher basis weights, for example, approximately 150 or more than 200 g/m², may provide greater resistance to deformation and greater resiliency and may be more suitable if the mask body is used to support an exhalation valve. Together with these minimum basis weights, the shaping layer typically has a maximum density of about 0.2 g/cm² over the central area of the mask. Typically, the shaping layer would have a thickness of about 0.3 to 2.0, more typically about 0.4 to 0.8 millimeters. Examples of shaping layers suitable for use in the present invention are described in the following patents: U.S. Pat. No. 5,307,796 to Kronzer et al., U.S. Pat. No. 4,807,619 to Dyrud et al., and U.S. Pat. No. 4,536,440 to Berg.

### Filtration Layer

Filter layers used in a mask body of the invention can be of a particle capture or gas and vapor type. The filter layer may also be a barrier layer that prevents the transfer of liquid from one side of the filter layer to another to prevent, for instance, liquid aerosols or liquid splashes from penetrating the filter layer. Multiple layers of similar or dissimilar filter types may be used to construct the filtration layer of the invention as the application requires. Filters beneficially employed in a laminated mask body of the invention are generally low in pressure drop (for example, less than about 20 to 30 mm H₂O at a face velocity of 13.8 centimeters per second) to minimize the breathing work of the mask wearer. Filtration layers additionally are flexible and have sufficient shear strength so that they do not delaminate under the expected use conditions. Generally the shear strength would be less than that of either the adhesive or shaping layers. Examples of particle capture filters include one or more webs of fine inorganic fibers (such as fiberglass) or polymeric synthetic fibers. Synthetic fiber webs may include electret charged polymeric microfibers that are produced from processes such as meltblowing. Polyolefin microfibers formed from polypropylene that are surface fluorinated and electret charged, to produce non-polarized trapped charges, provide particular utility for particulate capture applications. An alternate filter layer may comprise an sorbent component for removing hazardous or odorous gases from the breathing air. Absorbents and/or adsorbents may include powders or granules that are bound in a filter layer by adhesives, binders, or fibrous structures—see U.S. Pat. No. 3,971,373 to Braun. Sorbent materials such as activated carbons, that are chemically treated or not, porous alumna-silica catalyst substrates, and alumna particles are examples of adsorbents useful in applications of the invention. U.S. Pat. Nos. 7,309,513 and 7,004,990 to Brey et al., and U.S. Pat. No. 5,344,626 to Abler disclose examples of activated carbon that may be suitable.

The filtration layer is typically chosen to achieve a desired filtering effect and, generally, removes a high percentage of particles or other contaminants from the gaseous stream that passes through it. For fibrous filter layers, the fibers selected depend upon the kind of substance to be filtered and, typically, are chosen so that they do not become bonded together during the molding operation. As indicated, the filter layer may come in a variety of shapes and forms. It typically has a thickness of about 0.2 millimeters to 1 centimeter, more typically about 0.3 millimeters to 1 centimeter, and it could be a planar web coextensive with the shaping layer, or it could be a corrugated web that has an expanded surface area relative to the shaping layer—see, for example, U.S. Pat. Nos. 5,804,295 and 5,656,368 to Braun et al. The filtration layer also may include multiple layers of filter media joined together by an adhesive component—see U.S. Pat. No. 6,923,182 to Angadjivand et al.

Essentially any suitable material that is known (or later developed) for forming a filtering layer may be used as the filtering material. Webs of melt-blown fibers, such as those taught in Wente, Van A., Superfine Thermoplastic Fibers, 48 Indus. Engn. Chem., 1342 et seq. (1956), especially when in a persistent electrically charged (electret) form are especially useful (see, for example, U.S. Pat. No. 4,215,682 to Kubik et al.). These melt-blown fibers may be microfibers that have an effective fiber diameter less than about 20 micrometers (μm) (referred to as BMF for “blown microfiber”), typically about 1 to 12 μm. Effective fiber diameter may be determined according to Davies, C. N., The Separation Of Airborne Dust Particles, Institution Of Mechanical Engineers, London, Proceedings 1B, 1952. Particularly preferred are BMF webs that contain fibers formed from polypropylene, poly(4-methyl-1-pentene), and combinations thereof. Meltblown webs may be made using the apparatus and die described in U.S. Pat. Nos. 7,690,902, 6,861,025, 6,846,450, and 6,824,733 to Erickson et al. Electrically charged fibrillated-film fibers as taught in van Turnhout, U.S. Pat. RE 31,285, also may be suitable, as well as rosin-wool fibrous webs and webs of glass fibers or solution-blown, or electrostatically sprayed fibers, especially in microfiber form. Nanofiber webs also may be used as a filtering layer—see U.S. Pat. No. 7,691,168 to Fox et al. Electric charge can be imparted to the fibers by contacting the fibers with water as disclosed in U.S. Pat. No. 6,824,718 to Eitzman et al., U.S. Pat. No. 6,783,574 to Angadjivand et al., 6,743,464 to Insley et al., U.S. Pat. Nos. 6,454,986 and 6,406,657 to Eitzman et al., and U.S. Pat. Nos. 6,375,886 and 5,496,507 to Angadjivand et al. Electric charge also may be imparted to the fibers by corona charging as disclosed in U.S. Pat. No. 4,588,537 to Klasse et al. or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment—see U.S. Pat. Nos. 6,398,847 B1, 6,397,458 B1, and 6,409,806 B1 to Jones et al.; U.S. Pat. No. 7,244,292 to Kirk et al.; U.S. Pat. No. 7,244,291 to Spartz et al.; and U.S. Pat. No. 7,765,698 to Sebastian et al. Typical basis weights for electret BMF filtration layers are about 10 to 100 grams per square meter (g/m²). When electrically charged and optionally fluorinated as mentioned above, the basis weight may be about 20 to 40 g/m² and about 10 to 30 g/m², respectively.

A respirator of the invention also can be made which has only one layer that functions as both a shaping layer and a filtration layer. Such a respirator may have a mask body that contains thermally bonded staple fibers and non-thermally bonded electrically-charged microfibers—see U.S. Pat. No. 6,827,764 to Springett et al.

### Cover Web

The cover web can be used to entrap fibers that may come loose from the mask body and for aesthetic reasons. The cover web typically does not provide any substantial filtering benefits to the filtering structure, although it can act as a pre-filter when disposed on the exterior of (or upstream to) the filtration layer. The cover web preferably has a comparatively low basis weight and is formed from comparatively fine fibers. More particularly, the cover web may be fashioned to have a basis weight of about 5 to 50 g/m² (typically 10 to 30 g/m²), and the fibers may be less than 3.5 denier (typically less than 2 denier, and more typically less than 1 denier but greater than 0.1 denier). Fibers used in the cover web often have an average fiber diameter of about 5 to 24 micrometers, typically of about 7 to 18 micrometers, and more typically of about 8 to 12 micrometers. The cover web material may have a degree of elasticity (typically, but not necessarily, 100 to 200% at break) and may be plastically deformable.

Suitable materials for the cover web may be blown microfiber (BMF) materials, particularly polyolefin BMF materials, for example polypropylene BMF materials (including polypropylene blends and also blends of polypropylene and polyethylene). Cover webs can be made by introducing the loose cover web fibers into the forming chamber as described above. Alternatively, a cover web can be pre-made as described in U.S. Pat. No. 4,013,816 to Sabee et al. In the latter instance, the pre-made web may be formed by collecting the fibers on a smooth surface, typically a smooth-surfaced drum or a rotating collector—see U.S. Pat. No. 6,492,286 to Berrigan et al. Spun-bond fibers also may be used as loose fibers in assembling cover webs according to the invention.

A typical cover web may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material without requiring an adhesive between the layers. Polyolefin materials that are suitable for use in a cover web may include, for example, a single polypropylene, blends of two polypropylenes, and blends of polypropylene and polyethylene, blends of polypropylene and poly(4-methyl-1-pentene), and/or blends of polypropylene and polybutylene. One example of a fiber for the cover web is a polypropylene BMF made from the polypropylene resin “Escorene 3505G” from Exxon Corporation, providing a basis weight of about 25 g/m² and having a fiber denier in the range 0.2 to 3.1 (with an average, measured over 100 fibers of about 0.8). Another suitable fiber is a polypropylene/polyethylene BMF (produced from a mixture comprising 85 percent of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available, under the trade designations “Corosoft Plus 20”, “Corosoft Classic 20” and “Corovin PP-S-14”, from Corovin GmbH of Peine, Germany, and a carded polypropylene/viscose material available, under the trade designation “370/15”, from J.W. Suominen OY of Nakila, Finland.

Cover webs that are used in the invention generally have very few fibers protruding from the web surface after processing and therefore provide a smooth outer surface—see in U.S. Pat. No. 6,041,782 to Angadjivand, U.S. Pat. No. 6,123,077 to Bostock et al., and WO 96/28216A to Bostock et al.

### Respirator Components

The strap(s) that are used in the harness may be made from a variety of materials, such as thermoset rubbers, thermoplastic elastomers, braided or knitted yarn/rubber combinations, inelastic braided components, and the like. The strap(s) may be made from an elastic material such as an elastic braided material. The strap preferably can be expanded to greater than twice its total length and be returned to its relaxed state. The strap also could possibly be increased to three or four times its relaxed state length and can be returned to its original condition without any damage thereto when the tensile forces are removed. The elastic limit thus is generally not less than two, three, or four times the length of the strap when in its relaxed state. Typically, the strap(s) are about 20 to 30 cm long, 3 to 10 mm wide, and about 0.9 to 1.5 mm thick. The strap(s) may extend from the first side to the second side as a continuous strap or the strap may have a plurality of parts, which can be joined together by further fasteners or buckles. For example, the strap may have first and second parts that are joined together by a fastener that can be quickly uncoupled by the wearer when removing the mask body from the face. An example of a strap that may be used in connection with the present invention is shown in U.S. Pat. No. 6,332,465 to Xue et al. Examples of a fastening or clasping mechanism that may be used to joint one or more parts of the strap together is shown, for example, in the following U.S. Pat. No. 6,062,221 to Brostrom et al., U.S. Pat. No. 5,237,986 to Seppala, and EP1,495,785A1 to Chien and in U.S. Patent Publication 2009/0193628A1 to Gebrewold et al. and International Publication WO2009/038956A2 to Stepan et al.

An exhalation valve may be attached to the mask body to facilitate purging exhaled air from the interior gas space. The use of an exhalation valve may improve wearer comfort by rapidly removing the warm moist exhaled air from the mask interior. See, for example, U.S. Pat. Nos. 7,188,622, 7,028,689, and 7,013,895 to Martin et al.; U.S. Pat. Nos. 7,493,900, 7,428,903, 7,311,104, 7,117,868, 6,854,463, 6,843,248, and 5,325,892 to Japuntich et al.; U.S. Pat. Nos. 7,849,856 and 6,883,518 to Mittelstadt et al.; and RE 37,974 to Bowers. Essentially any exhalation valve that provides a suitable pressure drop and that can be properly secured to the mask body may be used in connection with the present invention to rapidly deliver exhaled air from the interior gas space to the exterior gas space.

### EXAMPLES

### Example 1

In making a filtering face piece respirator according to the invention, a fiber basis weight of between 300 and 500 grams per square meter (g/m²) was targeted to approximate the weight of a 3M 8210 respirator shell. A single screen mold was placed on a belt convex side up. Trevira™ 1.3 decitex (dtex) by 6 millimeters (mm)a PE/PET bicomponent binder fiber from Trevira GmbH in Hattersheim, Germany was placed in the air within a forming chamber. The air in the chamber was drawn through a porous mold screen to cause it to be deposited on the outer surface of the screen. The fibers accumulated on the mold screen were then bonded in an oven. The resulting cup-shaped product was fairly uniform and had a smooth nicely molded shape on the bottom (concave) side which contacted the screen. After the fibers in the web were bonded on the mold, the molded product was removed and the convex side of the web was placed against the concave side of the mold and run through the oven again. The web produced by the second pass through the oven had a smooth surface on both sides, since both sides had now been heated against the screen.

### Example 2

The procedure of Example 1 was followed, but two new molds were made which could be stacked on top of each other. This technique produced nicely molded smooth surfaces on both sides of the web and a uniform looking weight distribution throughout the web. The resulting product was a cup-shaped molded mask body that could be worn over the nose and mouth of a person.

### Example 3-7

Numerous fiber blends were used to generate cup-shaped products of varying uniformity and stiffness. As described above, the first blend (Example 3) consisted of 100% Trevira™ 1.3 decitex by 6 mm PE/PET bicomponent binder fiber from Trevira GmbH in Hattersheim, Germany. This fiber conformed nicely to both mold surfaces and produced a uniform web that had good stiffness and low fuzziness. The next fiber blend (Example 4) was a 100% 6 denier by 38 mm PET bi-component melty fiber sold under the brand Huvis™ by Huvis Corporation in Seoul, Republic of Korea. This fiber accumulation molded well but produced a web that lacked uniformity and stiffness and exhibited fuzziness. The third fiber blend (Example 5) was 100% Huvis™ 15 denier by 51 mm PET bi-component binder fiber. This fiber produced a filtering face piece mask body that exhibited a cup-shaped configuration that exhibited good uniformity and exceptionally good stiffness with some fuzziness on the concave surface. A sample (Example 6) also was made using 50/50 blends of the Trevira™ 1.3 decitex by 6 mm PE/PET bicomponent binder fiber and Ecora™ soy fiber from China Soybean Protein Fiber Co. Ltd in Jiangsu, China, and the Trevira™ 1.3 decitex by 6 mm PE/PET bicomponent binder fiber and 6 denier by 38 mm bi-component fiber from Huvis Corporation. Both of these blends produced good uniformity, stiffness, and shape with moderate fuzziness. Additional samples (Example 7) were made that contained 10% Trevira™ 1.3 decitex by 6 mm PE/PET bicomponent binder fiber and several other non-binder fibers. Some of these samples had good uniformity and shape but were fuzzy and lacked adequate stiffness.

### Examples C8-18

A 3M 8000 series respirator mold was used in place of the screen mold described in Example 1 to produce a series of samples containing 100% 4 denier by 51 mm Tairilin™ PET/PET binder fiber from Nan Ya Plastics Corporation, America in South Carolina. These samples were then tested for stiffness and pressure drop and were compared to the current 3M 8000 series shell (Comparative Examples C8 and C9). Pressure drop and Quality Factor (Q_{F}) were evaluated as described in U.S. Pat. No. 7,765,698 to Sebastian et al.) Table 1 shows the results for these tests.

TABLE 1
Test data

| Exam- | | Weight | Strength | Pressure drop | Q_{F} |
|---|---|---|---|---|---|
| ple | Blend | (g) | (lb) | (mm H2O) | (mm H2O⁻¹) |
| C8 | 8000 shell | 4.46 | 0.61 | 0.5 | n/a |
| C9 | 8000 w/ | 5.07 | 0.66 | 4.7 | n/a |
| | BMF | | | | |
| 10 | 100% | 3.73 | 0.56 | 0.3 | n/a |
| | 4 denier | | | | |
| | binder fiber | | | | |
| 11 | 100% | 4.14 | 1.21 | 0.5 | n/a |
| | 4 denier | | | | |
| | binder fiber | | | | |
| 12 | 100% | 4.47 | 0.87 | 0.3 | n/a |
| | 4 denier | | | | |
| | binder fiber | | | | |
| 13 | 100% | 3.14 | 0.6 | 0.2 | n/a |
| | 4 denier | | | | |
| | binder fiber | | | | |
| 14 | 100% | 5.12 | 1.89 | 0.5 | n/a |
| | 4 denier | | | | |
| | binder fiber | | | | |
| 15 | 100% | 4.85 | 1.9 | 0.5 | n/a |
| | 4 denier | | | | |
| | binder fiber | | | | |
| 16 | 100% | 7.79 | 2.83 | 0.1 | n/a |
| | 4 denier | | | | |
| | binder fiber | | | | |
| 17 | 100% | 10.14 | 4.3 | 3.93 | 0.15 |
| | Trevira ™ | | | | |
| 18 | 70%/30% | 6.74 | 0.92 | 0.8 | 0.56 |
| | Split Fiber*/ | | | | |
| | Trevira ™ | | | | |

*Split fiber are fibers produced according to U.S. Patent RE31,285.

The data in Table 1 shows that products can be successfully made using the method of the present invention. The pressure drops across the molded shells of the invention are similar to the pressure drops across the shaping layer in molded commercially-available respirators. Mask bodies made according to the invention also had good shell strength, that is, collapse resistance, without additional fiber mass. Example 18 further shows that good filter performance may be achieved from shells that contain electrically charged fibers. A molded mask body that demonstrates good filtration performance can be made in a one-step process.

### Example 19

Particle loaded respirator samples were made using two sizes of activated carbon and two types of fiber. The particles were loaded into the forming chamber using a gravity fed loader and were deposited along with the fibers onto the mold screen. A carbon loaded respirator was made using the Trevira™ binder fiber and 60×150 mesh carbon. The carbon particles and fibers in the resulting product were both uniformly distributed. The particles also were relatively well captured, however, there was some particle shedding. The web molded well, was smooth on both surfaces, and had good stiffness.

### Example 20

A carbon loaded respirator was made using the Trevira™ 1.3 decitex by 6 mm bicomponent binder fiber and 12×20 mesh carbon as described in Example 19. The particles were very well captured but not uniformly distributed. The web molded moderately well, was very stiff and had some fuzziness around the edges.

### Example 21

A carbon loaded respirator that was made as described in Example 19 using Huvis™ 15 denier by 51 mm PET bicomponent binder fiber and 60×150 mesh activated carbon. The particles in this respirator were uniformly distributed but not well captured. The web molded moderately well, was very stiff, and had some fuzziness around the edges.

### Example 22

A carbon loaded respirator sample was made which contained a reinforcing thermoplastic mesh. This method was carried out in a series of steps. First, a layer of Trevira™ 1.3 decitex by 6 mm bicomponent binder fiber and carbon was formed on the mold. The thermoplastic mesh was then placed on top of the fiber web. The second mold screen also was then placed on top on top of the mesh, and layered sample and screen were both run through the oven sandwiched between the two layers of screened molds. The top mold screen was removed and a second layer of Trevira™ 1.3 decitex by 6 mm bicomponent binder fiber and carbon was deposited on the mesh. The top mold screen was replaced, and the web was sent through the oven again. The resulting respirator was a cup-shaped product that had particle and gaseous filtration capabilities.

This invention may take on various modifications and alterations without departing from its spirit and scope. Accordingly, this invention is not limited to the above-described but is to be controlled by the limitations set forth in the following claims and any equivalents thereof.

This invention also may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

1-15. (canceled)

16. A filtering face piece respirator that comprises:
a mask body that comprises an in-situ web; and
a harness that is secured to the mask body.

17. The respirator of claim 16, wherein the in-situ web comprises fibers that are uniformly distributed throughout the in-situ web of the mask body.

18. The respirator of claim 16, wherein at least one of a shaping layer, a filter layer, and a cover web is an in-situ made web.

19. The respirator of claim 16, wherein the shaping layer and the filter layer are in-situ webs.

20. The respirator of claim 19, wherein the in-situ filter layer contains nonwoven fibers and activated carbon.

21. The respirator of claim 16, wherein the in-situ web contains thermally bonded staple fibers and electrically-charged microfibers.

22. The respirator of claim 21, wherein the electrically-charged microfibers comprise non-thermally bonded electrically-charged microfibers.

23. The respirator of claim 16, wherein the in-situ web of the mask body forms a shaping layer that comprises bicomponent staple fibers.

24. The respirator of claim 23, wherein the shaping layer further comprises synthetic staple fibers.

25. The respirator of claim 16, wherein the mask body further comprises an inner shaping layer, a filter layer, and an outer cover web, wherein the filter layer is disposed between the shaping layer and the outer cover web, wherein the in-situ web of the mask body forms the inner shaping layer, and further wherein each of the filter layer and outer cover web comprises an in-situ web.

26. The respirator of claim 25, wherein the mask body further comprises an inner cover web disposed such that the shaping layer is between the inner cover web and the filter layer.

27. The respirator of claim 26, wherein the inner cover web comprises an in-situ web.

28. The respirator of claim 16, wherein the mask body comprises a cup-shaped configuration.
